(19) United States
(12) Patent Application Publication
(10) Pub. No.: US 2016/0273191 A1
(43) Pub. Date: Sep. 22, 2016

(54) CENTER PINTLE HUB FOR A MACHINE

(71) Applicant: Caterpillar Global Mining LLC, South Milwaukee, WI (US)

(72) Inventors: Cheng-Kong C. Wu, Franklin, WI (US); Daniel T. Unger, Yorkville, IL (US); Vladimir A. Korchagin, Loves Park, IL (US); Jean M. Yaunke, Delavan, WI (US)

(73) Assignee: Caterpillar Global Mining LLC, South Milwaukee, WI (US)

(21) Appl. No.: 15/168,765

(22) Filed: May 31, 2016

(51) Int. Cl. E02F 9/12; F16C 11/04

(52) U.S. Cl. CPC E02F 9/121; F16C 11/04; E02F 3/308

(57) ABSTRACT

A center pintle hub coupled to a base of a machine is disclosed. The center pintle hub is casted as a single piece. The center pintle hub includes a disc, a hole, a plurality of protrusions, a hollow cylindrical member, and a plurality of stiffening members. The disc couples to the base and includes a first surface and a second surface. The hole extends from the first surface to the second surface, along a central axis of the disc. The plurality of protrusions, disposed on the second surface, is arranged in an array of square configuration. The plurality of protrusions extends from the second surface and attach to a plurality of stiffeners of the base. The hollow cylindrical member is coupled to the first surface and arranged coaxially with the hole of the disc. The plurality of stiffening members is circumferentially disposed and equally spaced around the hollow cylindrical member.

### TECHNICAL FIELD

The present disclosure relates to machines with revolving frames. More particularly, the present disclosure relates to a center pintle hub that facilitates rotation of the frame relative to a carbody of the machine.

### BACKGROUND

Swivel work machines, such as excavators, hydraulic shovels, rope shovels, and the like are typically employed in construction and mine sites. Such machines generally include a base (also known as carbody) that is supported by ground-engaging components and is configured to support a revolving frame thereon. In addition, the machines include a swing mechanism that may be directly secured to the frame to rotate the frame relative to the base. The frame is rotatably driven by one or more swing drives of the swing mechanism. The swing mechanism may include a pintle assembly for rotatably coupling the frame to the base. In such an arrangement, the swing mechanism rotates the revolving frame with respect to the base during operation. The pintle assembly is disposed between the frame and the base. The pintle assembly includes a center pintle hub and a center pintle shaft. The center pintle hub is welded to the base and is structured to support and accommodate a lower end of the center pintle shaft. An upper end of the center pintle shaft is attached to the frame via fasteners. During operation, the swing mechanism rotates the center pintle shaft that rotates the frame with respect to the base.

Typically, the center pintle hub is composed of multiple welded pieces, which could be standard rolled or forged pieces of consistently high strength. For secure attachment of the center pintle hub to the frame, it is required that each piece of the center pintle hub is welded to the frame. Welding of multiple pieces of the center pintle hub to the base poses difficulty to manufacturers in the welding process as the pieces are located in difficult to access positions. The conventional design may limit the load-bearing strength of the center pintle hub, as welding of multiple pieces may cause onset of fracture upon under operation loads. In addition, welding of multiple pieces may reduce durability of the center pintle hub due to multiple welded joints. Hence, this may result in weld cracks during and after the manufacturing process.

U.S. Pat. No. 2,144,760 describes a support structure for a center pintle. The support structure for the center pintle is made of rolled, forged sheets of different shapes. The sheets used for the support structure are attached together by various means such as welding, bolting, and riveting. However, current structures do not prevent fractures from occurring in the weld areas of the center pintle hub. Hence, there is a need for a system that addresses issues related to the welding breakdowns in the center pintle hub.

### SUMMARY OF THE DISCLOSURE

Various aspects of this disclosure describe a center pintle hub for a machine. The machine includes a frame that is supported on a base. The disclosed center pintle hub is casted as a single piece. The center pintle hub includes a disc, a hole, a plurality of protrusions, a hollow cylindrical member, and a plurality of stiffening members. The disc includes a first surface that faces the frame and a second surface that faces the base. The disc is coupled to the base. The hole extends from the first surface to the second surface. The hole is disposed along a central axis of the disc. The plurality of protrusions is disposed on the second surface. The plurality of protrusions is arranged in an array of square configuration. The plurality of protrusions extends from the second surface. The plurality of protrusions is attached to a plurality of stiffeners of the base, thereby coupling the disc to the base. The hollow cylindrical member is coupled to the first surface and is arranged coaxially with the hole of the disc. The plurality of stiffening members is circumferentially disposed and equally spaced around the hollow cylindrical member.

### BRIEF DESCRIPTION OF THE DRAWINGS

FIG. 1 is a diagrammatic view of an exemplary machine that include a frame and a base, in accordance with the concepts of the present disclosure;

FIG. 2 is a perspective view of a center pintle hub assembled on the base, in accordance with the concepts of the present disclosure;

FIG. 3 is a cross-section of the center pintle hub and the base along section line X-X of FIG. 2, in accordance with the concepts of the present disclosure;

FIG. 4 is a top perspective view of the center pintle hub, in accordance with the concepts of the present disclosure; and

FIG. 5 is a bottom perspective view of the center pintle hub, in accordance with the concepts of the present disclosure.

### DETAILED DESCRIPTION

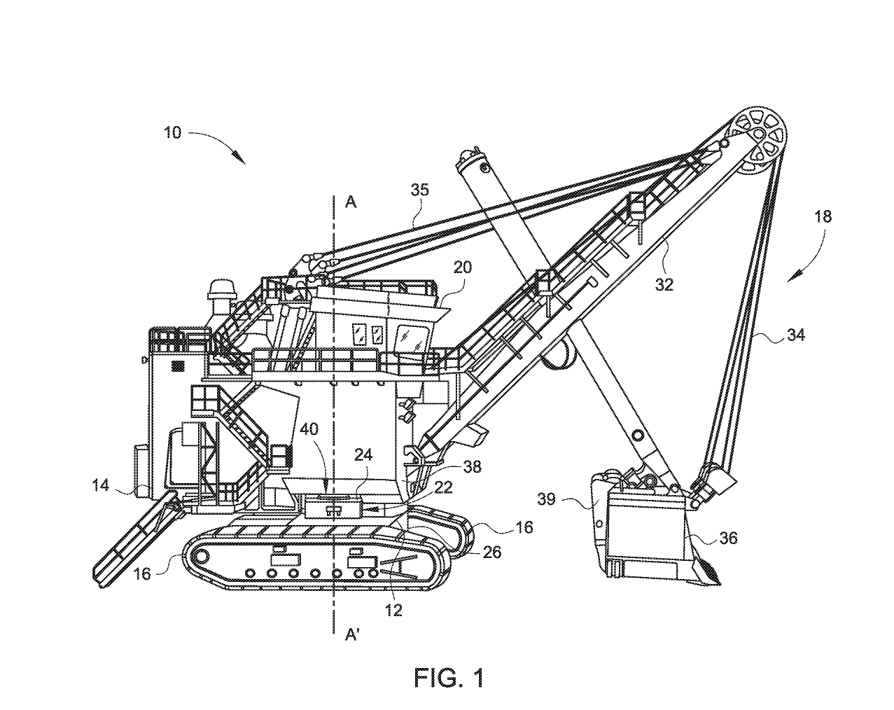

FIG. 1 illustrates an exemplary machine 10. As used herein, the term “machine” may refer to any machine that performs some type of operation associated with an industry such as mining, construction, transportation, marine, or any other industry known in the art. For example, the machine 10 may embody an earth-moving machine such as a rope shovel depicted in FIG. 1.

The machine 10 may include a base 12, a frame 14, a pair of crawler tracks 16, an implement assembly 18, an operator station 20, and a swing drive assembly 22.

The base 12 supports movement of the machine 10. The base 12 includes a top portion 24 and two lateral edges 26. The top portion 24 of the base 12 is configured to support the frame 14 thereon. The base 12 may also be referred by term “carbody.”

Each of the pair of the crawler tracks 16 include a roller frame (not shown), thereby making a pair of roller frames. The roller frames are attached to the lateral edges 26 of the base 12, thereby supporting the base 12. The crawler tracks 16 are moved by sprockets (not shown) that are powered by a prime mover (not shown) supported by the frame 14. In the disclosed exemplary application, the base 12 is movable, with the crawler tracks 16 that are driven to propel the machine 10 over a work surface.

The frame 14 is supported on the base 12. The frame 14 supports the implement assembly 18, the operator station 20, and the swing drive assembly 22. The frame 14 pivots relative to the base 12, about a substantially vertical axis A-A′. As the frame 14 pivots about the vertical axis A-A′, the implement assembly 18 and the operator station 20 also pivot together with the frame 14. This changes an angular position of the implement assembly 18 relative to the base 12.

Rotation of the frame 14 allows the implement assembly 18 to rotate about the vertical axis A-A′ of the base 12. This allows the implement assembly 18 to perform various functions such as transporting dirt or other mining material after scooping the same from the work surface. The implement assembly 18 includes a boom 32, a set of hoist cables 34, a set of suspension cables 35, and an implement 36. The boom 32 may be pivotally connected at a front end 38 of the frame 14. The boom 32 may be constrained at a desired vertical angle relative to work surface, by the suspension cables 35. The hoist cables 34 connect the implement 36 to the frame 14.

In the illustrated embodiment of FIG. 1, the implement 36 is a dipper. The dipper is a type of shovel bucket having a pivotal door 39. Reeling in and spooling out of the hoist cables 34 may affect a height and angle of the implement 36 relative to the work surface. Although the dipper is depicted in FIG. 1, in other embodiments, the implement 36 may alternatively embody a grapple bucket, a blade ripper, a breaker, an auger, and the like. Therefore, it is to be noted that a type of the implement 36 used is merely exemplary in nature and hence, non-limiting of this disclosure. The type of implement 36 used may vary from one application to another depending on specific requirements of an application.

The operator station 20 is rigidly mounted on the frame 14. The operator station 20 allows an operator to control the implement assembly 18 and the swing drive assembly 22. The operator station 20 may include one or more operator interface devices (not shown) for example a joystick, a steering wheel, user interfaces, indicators, or a pedal (none of which are shown but are well known in the art). Movement of the operator interface devices may initiate movement of the crawler tracks 16, the implement 36, and the swing drive assembly 22, by producing displacement signals that are indicative of desired maneuvering.

The swing drive assembly 22 of the machine 10 rotatably connects the base 12 and the frame 14, in order to facilitate rotation of the frame 14 relative to the base 12. The swing drive assembly 22 includes a center pintle assembly 40 to facilitate a 360-degree rotation of the frame 14 relative to the base 12. The swing drive assembly 22 may additionally include one or more swing motors, a swing gear, rollers, and other components (none of which are shown but are well known in the art). Explanation to the center pintle assembly 40 will be made hereinafter.

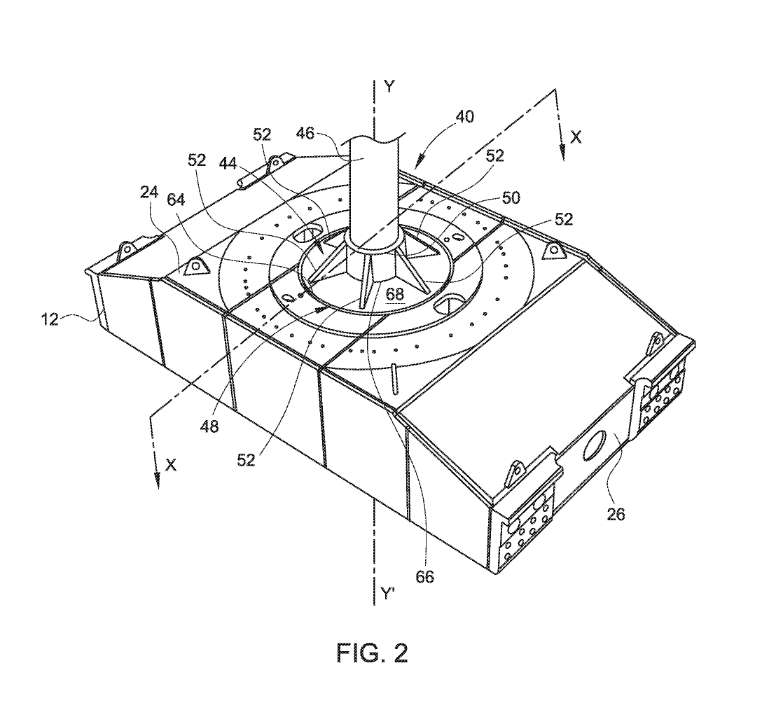

Referring to FIG. 2, the center pintle assembly 40 is shown mounted on the base 12. The top portion 24 of the base 12 includes a mounting location for the center pintle assembly 40 close to a center of the base 12. The center pintle assembly 40 includes a center pintle hub 44 and a center pintle shaft 46.

The center pintle shaft 46 counteracts horizontal and vertical forces exerted on the frame 14 during shovel operation. An upper end (not shown) of the center pintle shaft 46 is fixedly attached to the frame 14 (refer to FIG. 1) so as to house a top portion (not shown) of the center pintle shaft 46 inside the frame 14. A lower end of the center pintle shaft 46 is supported inside the base 12 via the center pintle hub 44.

Referring to FIGS. 2-4, the center pintle hub 44 includes a disc 48, a hollow cylindrical member 50, a plurality of stiffening members 52, and a plurality of protrusions 56, 58, 60, and 62. In an example as shown in FIG. 2, six stiffening members 52 are shown included in the center pintle hub 44. The disc 48 facilitates welding of the center pintle hub 44 to the base 12.

The disc 48 includes an outer circumference 64, an inner circumference 66, a first surface 68, and a second surface 70. The first surface 68 is defined between the outer circumference 64 and the inner circumference 66 on a top side of the disc 48, such that the first surface 68 faces the frame 14. The disc 48 may be coupled by welding to the base 12 along the outer circumference 64.

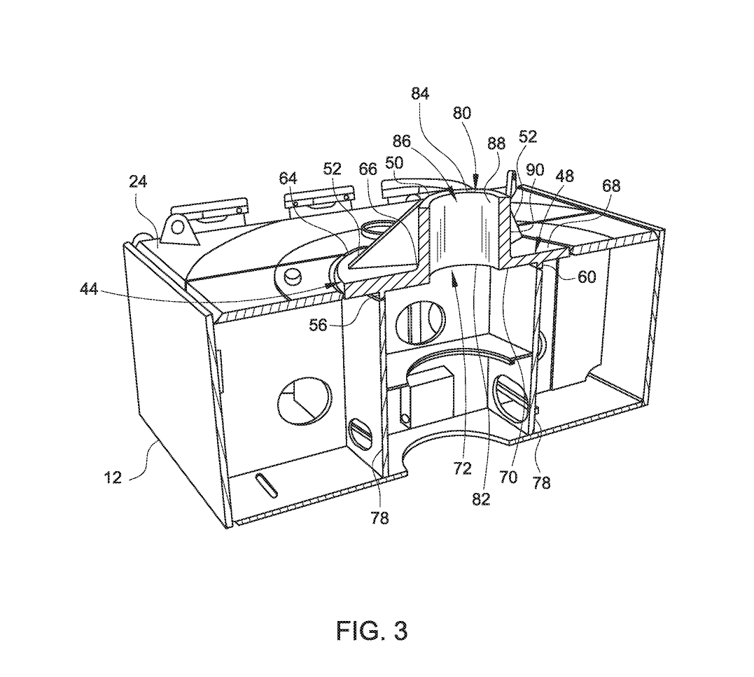

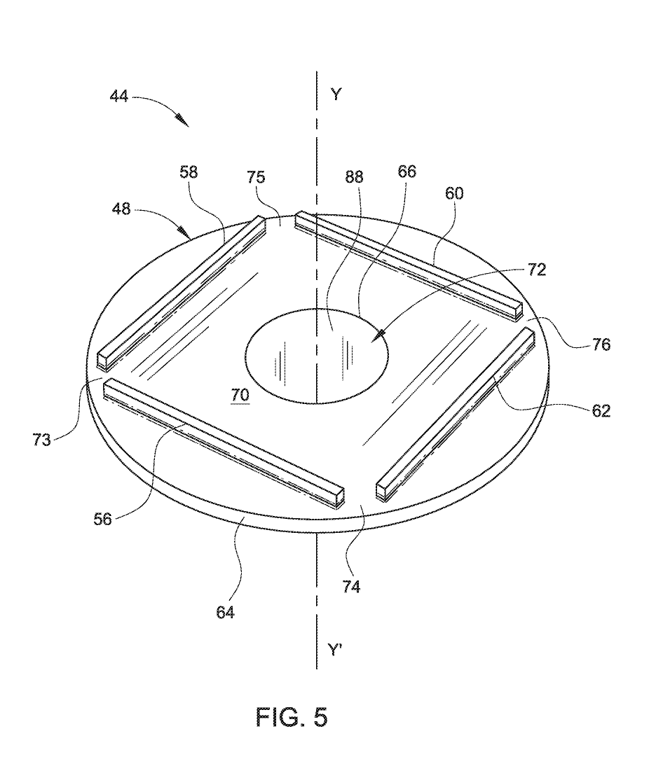

Further, the center pintle hub 44 includes a hole 72 (refer to FIGS. 3 and 5). The inner circumference 66 defines the hole 72. The hole 72 extends from the first surface 68 to the second surface 70. The hole 72 is oriented along a central axis Y-Y′ of the disc 48.

FIG. 3 shows a sectional view of the center pintle hub 44 and the base 12 taken along a section line X-X of FIG. 2. Referring to FIG. 3 and FIG. 5, the second surface 70 is defined between the outer circumference 64 and the inner circumference 66, such that the second surface 70 faces the base 12.

The plurality of protrusions 56, 58, 60, and 62, will be hereinafter referred to as the protrusions 56, 58, 60, and 62. The protrusions 56, 58, 60, and 62 is disposed and arranged on the second surface 70 of the disc 48. Referring to FIG. 5, the protrusions 56, 58, 60, and 62 are arranged in an array of square configuration on the second surface 70. Each of the protrusions 56, 58, 60, and 62 are uniformly distant from the hole 72 of the disc 48. Each of the protrusions 56, 58, 60, and 62 extends downward from the second surface 70. The protrusions 56, 58, 60, and 62 are substantially bar-shaped. The protrusions 56, 58, 60, and 62 are similar in dimensions (height, width, and length). The protrusion 56 is adjacent to the protrusions 58 and 62, thereby defining a first gap 73 and a second gap 74, respectively. In addition, the protrusion 56 is positioned opposite to the protrusion 60. Similarly, the protrusion 58 is positioned opposite to the protrusion 62. The protrusion 60 is adjacent to the protrusions 58 and 62, thereby defining a third gap 75 and a fourth gap 76, respectively. With reference to FIG. 3, the protrusions 56, 58, 60, and 62 are coupled to the base 12, via welding of the protrusions 56, 58, 60, and 62 with a plurality of vertical stiffeners 78. This facilitates attachment of the disc 48 to the base 12. It may be contemplated that in an alternative embodiment, the protrusions 56, 58, 60, and 62 may be continually attached to each other to form a closed square structure, eliminating the gaps 73, 74, 75, and 76.

In another alternative embodiment, the center pintle hub 44 may be casted with no protrusions 56, 58, 60, and 62 on the second surface 70. Without the protrusions 56, 58, 60, and 62, the second surface 70 of the disc 48 may be directly welded to the vertical stiffeners 78 of the base 12.

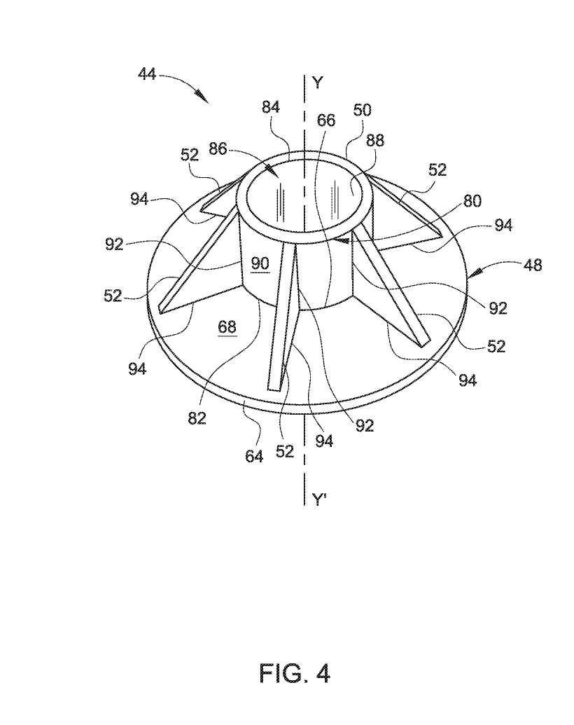

Referring to FIGS. 4-5, there is shown the center pintle hub 44 that is casted as a single piece. The hollow cylindrical member 50 is coupled to the first surface 68 of the disc 48. The hollow cylindrical member 50 is arranged coaxially with the hole 72 of the disc 48. The hollow cylindrical member 50 includes a cylindrical wall 80, a first lateral end 82, a second lateral end 84, and a central bore 86.

The first lateral end 82 is proximal to the base 12 and the second lateral end 84 is proximal to the frame 14. The cylindrical wall 80 is defined between the first lateral end 82 and the second lateral end 84. The first lateral end 82 is fixed to the first surface 68 of the disc 48.

The cylindrical wall 80 includes an inner surface 88 and an outer surface 90. The inner surface 88 defines the central bore 86 of the hollow cylindrical member 50 along the central axis Y-Y′. The central bore 86 of the hollow cylindrical member 50 is aligned with the hole 72 of the disc 48. The central bore 86 is structured to receive the center pintle shaft 46.

The stiffening members 52 are attached to the hollow cylindrical member 50 along the outer surface 90 of the cylindrical wall 80. The stiffening members 52 are radially arranged around the hollow cylindrical member 50, such that each of the stiffening members 52 is equidistantly spaced from an adjacent one of the stiffening members 52. In the present embodiment, the stiffening members 52 are triangular in shape. Each of the stiffening members 52 includes a first side 92 and a second side 94 perpendicular to each other. The first side 92 of each stiffening member 52 is therefore disposed in rigid abutment with the outer surface 90 of the cylindrical wall 80. The second side 94 of the stiffening member 52 abuts on the first surface 68 of the disc 48. It may be contemplated that the stiffening members 52 may embody other shapes and sizes.

An alternative design of the center pintle hub may be contemplated, but is not shown in the figures. In the alternative design, the center pintle hub may include a bottom portion, a top portion, and a hollow cylindrical member. The bottom portion may include a square periphery. Welding along the square periphery may facilitate attachment of the center pintle hub to the base. The hollow cylindrical member may be disposed between the top portion and the bottom portion. The hollow cylindrical member may include a central bore, which is structured to accommodate the center pintle shaft. The center pintle hub may include three or more stiffening members positioned between the bottom portion and the top portion. The stiffening members are fixed to the hollow cylindrical member. The stiffening member may be of any shape and size.

### INDUSTRIAL APPLICABILITY

In operation, the swing motors rotatably drive the pinions that are engaged with the swing gear. The frame 14 is supported by the rollers, and hence rotates relative to the base 12. On rotation of the frame 14, the center pintle shaft 46 also rotates relative to the center pintle hub 44. The center pintle hub 44 allows rotation of the center pintle shaft 46 within the hollow cylindrical member 50. The center pintle shaft 46 is disposed in the center pintle hub 44 to counteract the horizontal and vertical forces exerted on the frame 14 during the shovel operation.

In embodiments herein, the center pintle hub 44 of the center pintle assembly 40 is welded with the base 12 of the machine 10 to form a unitary support structure for the center pintle shaft 46. The center pintle hub 44 includes the disc 48, the hollow cylindrical member 50, and the stiffening members 52. The single piece casting of the center pintle hub 44 eliminates structure failure concerns associated with a component embodying multiple pieces due to elimination of welded joints within the center pintle hub 44. The disclosed center pintle hub 44 is characterized with an increased overall strength and durability and is hence, less susceptible to fractures. Further, the stiffening members 52 impart stiffness to the piece and help control stress and deflection caused by machine operation.

The disclosed center pintle hub 44 is easy to attach to the base 12 by welding. Compared to existing hub designs, the disclosed center pintle hub 44 provides a regular profile for welding to the base 12. In addition, the disclosed design allows welding of the center pintle hub 44 to the base 12 from accessible locations. For example, referring to FIG. 3, the first surface 68 of the disc 48 is welded to the top portion 24 of the base 12, which can be performed conveniently along the outer circumference 64. The protrusions 56, 58, 60, and 62 on the second surface 70 of the disc 48 are welded to the vertical stiffeners 78 of the base 12. Thus, this allows welding of the center pintle hub 44 to be performed easily while also reducing the time consumed in performing the welding operation.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claim(s) and any equivalents thereof.

What is claimed is:

1. A center pintle hub for a machine having a frame being supported on a base, the center pintle hub comprising:
a disc having a first surface facing the frame and a second surface facing the base, the disc being coupled to the base;
a hole extending from the first surface to the second surface and disposed along a central axis of the disc;
a plurality of protrusions disposed on the second surface and arranged in an array of square configuration, the plurality of protrusions extending from the second surface, wherein the plurality of protrusions is attached to a plurality of stiffeners of the base thereby coupling the disc to the base;
a hollow cylindrical member coupled to the first surface and arranged coaxially with the hole of the disc; and
a plurality of stiffening members being circumferentially disposed and equally spaced around the hollow cylindrical member.

2. The center pintle hub of claim 1, wherein the center pintle hub is casted as a single piece.
